(19) United States
(12) Patent Application Publication
(10) Pub. No.: US 2025/0317232 A1
(43) Pub. Date: Oct. 9, 2025

(54) METHOD FOR SESSIONS SYNCHRONIZATION FOR ARMAMENT MESSAGE ANALYSIS

(71) Applicant: Aeronix, Inc., Melbourne, FL (US)

(72) Inventors: Patrick Hagerty, Melbourne, FL (US); Ted Dubroff, Melbourne, FL (US); Levi Mutter, Melbourne, FL (US)

(73) Assignee: Aeronix, Inc., Melbourne, FL (US)

(21) Appl. No.: 19/170,139

(22) Filed: Apr. 4, 2025

Related U.S. Application Data
(60) Provisional application No. 63/574,591, filed on Apr. 4, 2024.

(51) Int. Cl. H04J 3/06; H04L 67/12

(52) U.S. Cl. CPC H04J 3/0661; H04L 67/12

(57) ABSTRACT

A method for displaying synchronized messages comprising the steps of: (1) receiving a first message having a first timestamp in a first format; (2) converting the first timestamp from the first format to a universal format; (3) displaying information related to the first message; (4) selecting a time range; (5) comparing the first timestamp in the universal format to the selected time range; and (6) providing a first visual indication to inform a user when the first timestamp is in the selected time range.

### RELATED APPLICATIONS

This application claims priority under 35 U.S.C. § 119 (e) of U.S. Provisional Patent Application Ser. No. 63/574,591 (Attorney Docket No. 1949.00019) filed on Apr. 4, 2024 and titled METHOD FOR SESSIONS SYNCHRONIZATION FOR ARMAMENT MESSAGE ANALYSIS. The content of this application is incorporated herein by reference.

### FIELD OF THE INVENTION

The present invention relates to systems and methods for synchronizing and displaying UAI messages for analysis.

### BACKGROUND OF THE INVENTION

When using a Universal Armament Interface (UAI), captures of multiple buses from different sources often have to be accomplished in order to comply with the specifications of the standard. There are often instances in which it may be useful to quickly and easily determine what is happening on across a plurality of buses at the same instant in time. Therefore, a need exists for a system that provides a time synchronized visual display of a plurality of messages across different sessions.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a method for displaying synchronized messages including the steps of: (1) receiving a first message having a first timestamp in a first format; (2) converting the first timestamp from the first format to a universal format; (3) displaying information related to the first message; (4) selecting a time range; (5) comparing the first timestamp in the universal format to the selected time range; and (6) providing a first visual indication to inform a user when the first timestamp is in the selected time range.

The method may further include the steps of: (7) receiving a second message having a second timestamp in a second format; (8) converting the second timestamp from the second format to the universal format; (9) displaying information related to the second message; (10) comparing the second timestamp in the universal format to the selected time range; and (11) providing a second visual indication to inform the user when the second timestamp is in the selected time range.

In one embodiment, the method for displaying synchronized messages may include the steps of: (1) receiving a first message having a first timestamp in a first format; (2) receiving a second message having a second timestamp in a second format; (3) converting the first timestamp from the first format to a universal format; (4) converting the second timestamp from the second format to the universal format; (5) displaying information related to the first message; (6) displaying information related to the second message; (7) selecting a time range; (8) comparing the first timestamp in the universal format to the selected time range; (9) comparing the second timestamp in the universal format to the selected time range; (10) providing a first visual indication to inform a user when the first timestamp is in the selected time range; and (11) providing a second visual indication to inform the user when the second timestamp is in the selected time range.

In one embodiment, the first format may be different than the second format.

The first message may be transmitted by a first hardware monitor and the second message may be transmitted by a second hardware monitor.

In one embodiment, a plurality of second messages from the second hardware monitor may be received and the second visual indication may identify which of the plurality of second messages is the time range. In one embodiment, only one of the plurality of second messaged may be in the time range.

The first visual indication and the second visual indication may be displayed in a single user interface.

The time range may be selected by (1) selecting the first message; and (2) defining the time range based on the timestamp of the first message.

In one embodiment, the method may further include the steps of: (1) converting the time stamp in the second format of each of the plurality of second messages to the universal format; (2) comparing the timestamp in the universal format of each of the plurality of second messages to the timestamp in the universal format of the first message; and (3) selecting only a one of the plurality of second messages having the timestamp in the universal format closest in time to the timestamp in the universal format of the first message to be in the selected time range.

The method may further include the steps of: (1) receiving a plurality of third messages from a third hardware monitor, wherein each of the plurality of third messages has a timestamp; (5) converting the timestamp of each of the plurality of third messages to the universal format; (6) comparing the timestamp in the universal format of each of the plurality of third messages to the timestamp in the universal format of the first message; (7) selecting only a one of the plurality of third messages having a timestamp in the universal format closest in time to the timestamp in the universal format of the first message to be in the selected time range; and (8) providing a third visual indication to indicate the one of the plurality of third messages in the selected time range.

The first visual indication, the second visual indication, and the third visual indication may be displayed in a single user interface.

In one embodiment, the method for displaying synchronized messages may include the steps of: (1) receiving a plurality of first messages transmitted by a first hardware monitor, wherein the each of the plurality of first messages has a first timestamp in a first format; (2) receiving a plurality of second messages transmitted by a second hardware monitor, wherein each of the plurality of second messages has a second timestamp in a second format and the second format is different than the first format; (3) receiving a plurality of third messages transmitted by a third hardware monitor, wherein each of the plurality of third messages has a third timestamp in a third format and the third format is different than the second format and the first format; (4) converting the first timestamps of each of the plurality of first messages from the first format to a universal format; (5) converting the second timestamps of each of the plurality of second messages from the second format to the universal format; (6) converting the third timestamps of each of the plurality of third messages from the third format to the universal format; (7) displaying information related to the first message; (8) displaying information related to the second message; (9) displaying information related to the third message; (10) selecting one of the plurality of first messages; (11) providing a first visual indication to indicate the selected one of the plurality of first messages; (12) defining a target time as the value of the first timestamp in the universal format of the selected one of the plurality of first messages; (13) comparing the second timestamps in the universal format of each of the plurality of second messages to the target time; (14) providing a second visual indication to indicate a one of the plurality of second messages having the second timestamp in the universal format closest in time to the target time; (15) comparing the third timestamps in the universal format of each of the plurality of third messages to the target time; and (16) providing a third visual indication to indicate a one of the plurality of third messages having the third timestamp in the universal format closest in time to the target time.

In one embodiment, the plurality of first messages, plurality of second messages, and plurality of third messages may be received from a universal armament interface bus.

### BRIEF DESCRIPTION OF THE DRAWINGS

Some embodiments of the present invention are illustrated as an example and are not limited by the figures of the accompanying drawings, in which like references may indicate similar elements.

FIG. 1 is a flow chart of the inventive method according to one embodiment of the invention.

FIG. 2 is a flow chart of the inventive method according to one embodiment of the invention.

FIG. 3 is a flow chart of the method of selecting a time range according to an embodiment of the invention.

FIG. 4 is a flow chart of the inventive method according to one embodiment of the invention.

FIG. 5 is a flow chart of the inventive method according to one embodiment of the invention.

FIG. 6 is a flow chart of the inventive method according to one embodiment of the invention.

FIG. 7 is a flow chart of the inventive method according to one embodiment of the invention.

FIG. 8 is a flow chart of the inventive method according to one embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a method for displaying synchronized messages 100. The method 100 may be particularly useful for Universal Armament Interface (UAI) message analysis.

A software program may implement the inventive method 100 on messages received in real time or from a previously recorded file. There may be a plurality of hardware monitors, each transmitting a plurality of messages. The inventive method 100 may analyze the messages transmitted by each of the plurality of hardware monitors, detect messages sent in time proximity to one other, and provide an indication to a user of the method of what messages from each hardware monitor were sent in proximate time to one another.

Each hardware monitor may provide a timestamp as part of the message. Not all of the hardware monitors may provide the timestamp in the same format. Therefore, the method 100 may convert the timestamp format of each hardware monitor to a universal format and use the universal format of the timestamp to compare when messages are sent relative to one another. A user may select a message that is send by one hardware monitor, the method 100 may determine the timestamp in universal format of that message and then provide a visual indication to the user of messages sent by one or more other hardware monitors having timestamps in universal format proximate the timestamp of the selected message. In one embodiment, messages with timestamps that have equal values may be visually indicated. In one embodiment, messages with timestamps that are within a selectable amount of time from the timestamp of the selected message may be visually indicated. In one embodiment, messages with timestamps from each of the hardware monitors, which are closest in time to the timestamp of the selected message may be visually indicated.

The method 100 may utilized in a situation in which there are a plurality of open sessions. Each open session may be associated with at least one hardware monitor. In one embodiment, by way of example, and not as a limitation, a session may be a previously recorded file that has been opened in a program or a session may be live bus monitor output. Messages from every open session may be displayed by a graphical user interface (GUI).

Using the inventive method 100, a user may utilize the GUI to select a message in a session. The message may be displayed in a portion of a GUI associated with a first session. Selection of that message may cause the GUI to highlight, or otherwise visually indicate, the closest timestamp message in one or more of a remaining plurality of open sessions. The timestamp message may be visually indicated, by way of example, and not as a limitation, by changing a background, color, font, or type style in which the timestamp message is displayed. Visually indicating the messages from multiple sessions, which occur around the same instance in time, may be beneficial for troubleshooting and message analysis. This visual indication may be particularly beneficial for universal armament interface (UAI) message analysis.

Each of the plurality of open sessions may have a unique timestamp format. In an embodiment having N open sessions, there may be between 1 and N different formats for the timestamp with at least one timestamp format associated with each open session. Each of the timestamp formats may be converted to a universal format and comparisons between relative times may occur in the universal format.

The method 100 may include a timestamp acquiring mechanism. This timestamp acquiring mechanism may be adapted to recognize one or more timestamps on one or more open sessions. Once a timestamp is recognized, it may be recorded and associated with one or more fields of a message on an open session.

The method 100 may include a plurality of timestamp converters, each of which converts the timestamp format associated with one or more open sessions to a universal timestamp format. When a user selects a field, the system may compare the value of the timestamp of that field with the universal timestamp format timestamp values of fields in other open sessions to determine which other messages occurred at or near the same time as the selected field. Once the messages proximate in time are determined, the system may direct the GUI to visually indicate one or more fields in those messages.

The system may have a configurable threshold value to determine what falls within a “proximate in time” requirement. Messages occurring within the threshold amount of time, before, after, or both of the selected field, may be visually indicated by the GUI.

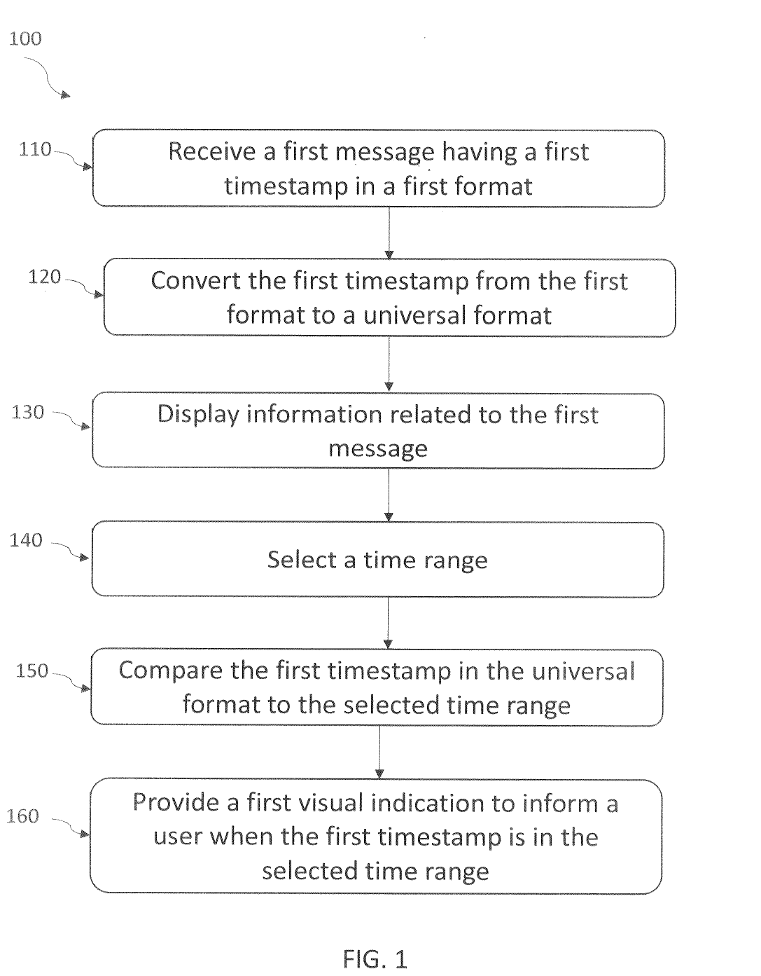

In one embodiment of the invention, as depicted at least in FIG. 1, the method for displaying synchronized messages 100 may include the steps of: receiving a first message having a first timestamp in a first format (110); converting the first timestamp from the first format to a universal format (120); displaying information related to the first message (130); selecting a time range (140); comparing the first timestamp in the universal format to the selected time range (150); and providing a first visual indication to inform a user when the first timestamp is in the selected time range (160).

The first message may be received from a UAI bus.

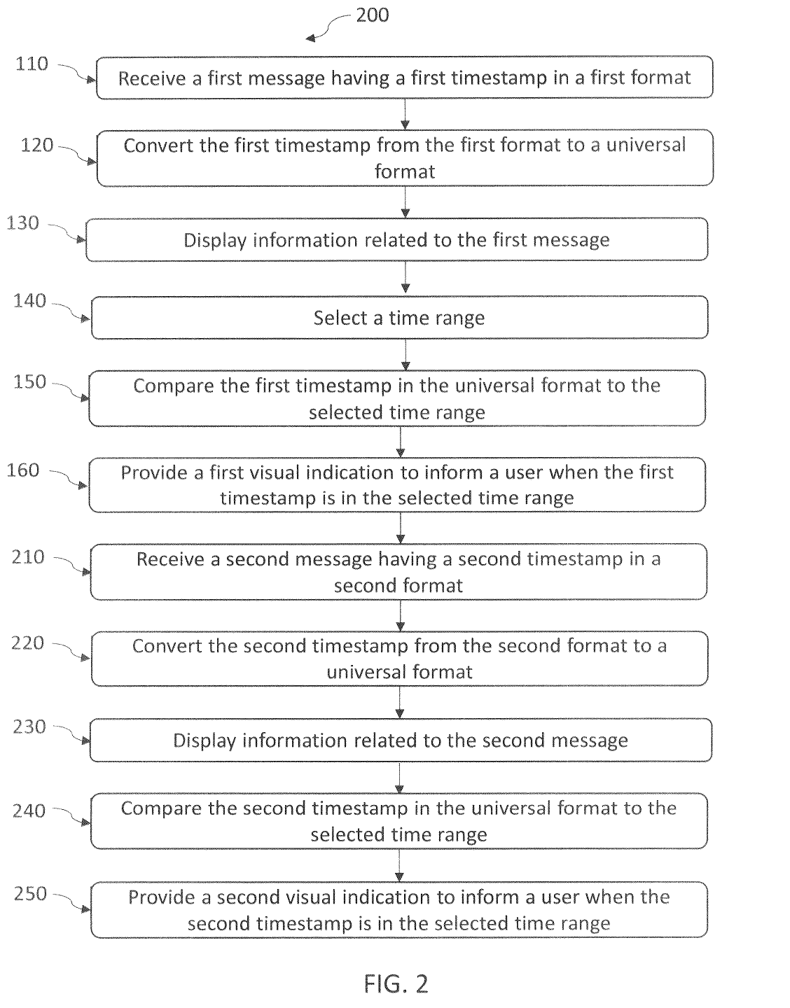

The method 200, as depicted at least in FIG. 2 may further include the steps of: receiving a second message having a second timestamp in a second format (210); converting the second timestamp from the second format to the universal format (220); displaying information related to the second message (230); comparing the second timestamp in the universal format to the selected time range (240); and providing a second visual indication to inform the user when the second timestamp is in the selected time range (250).

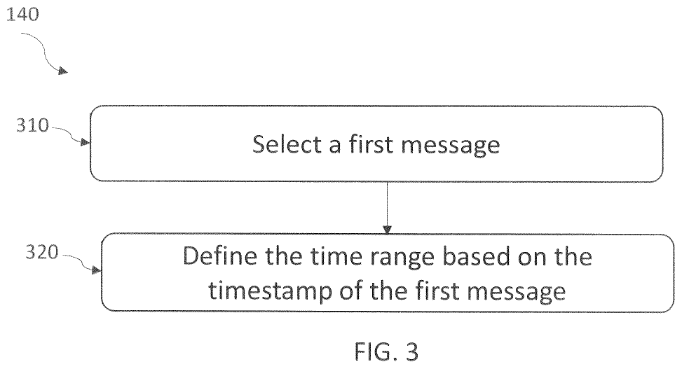

As depicted at least in FIG. 3, the step of selecting a time range (140) may include the steps of: selecting the first message (310) and defining the time range based on the timestamp of the first message (32).

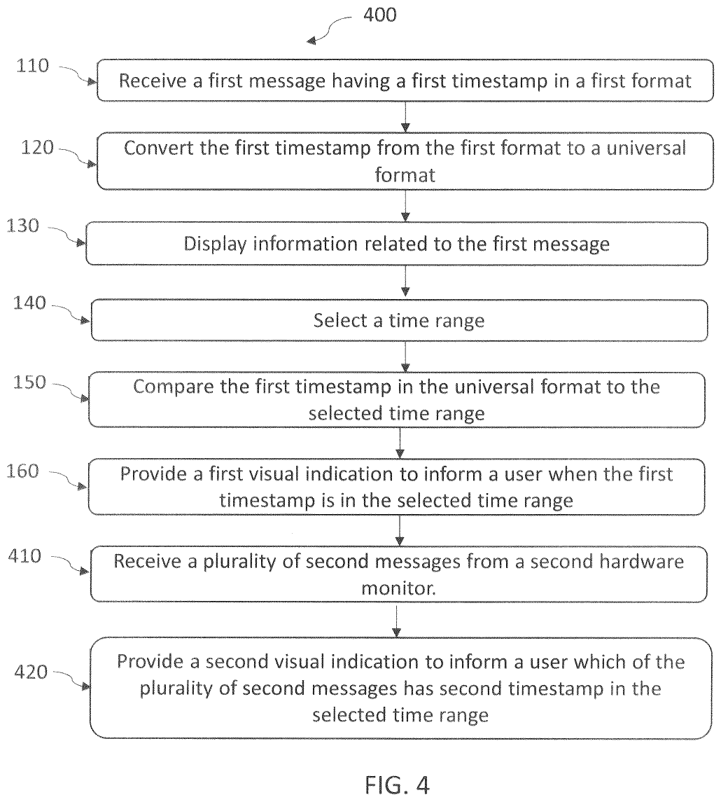

As depicted at least in FIG. 4, the method for displaying synchronized messages 400 may include the steps of: receiving a first message having a first timestamp in a first format (110); converting the first timestamp from the first format to a universal format (120); displaying information related to the first message (130); selecting a time range (140); comparing the first timestamp in the universal format to the selected time range (150); providing a first visual indication to inform a user when the first timestamp is in the selected time range (160); receiving a plurality of second messages from a second hardware monitor (410); and providing a second visual indication to inform the user which of the plurality of second messages has a second timestamp in the universal format in the time range (420).

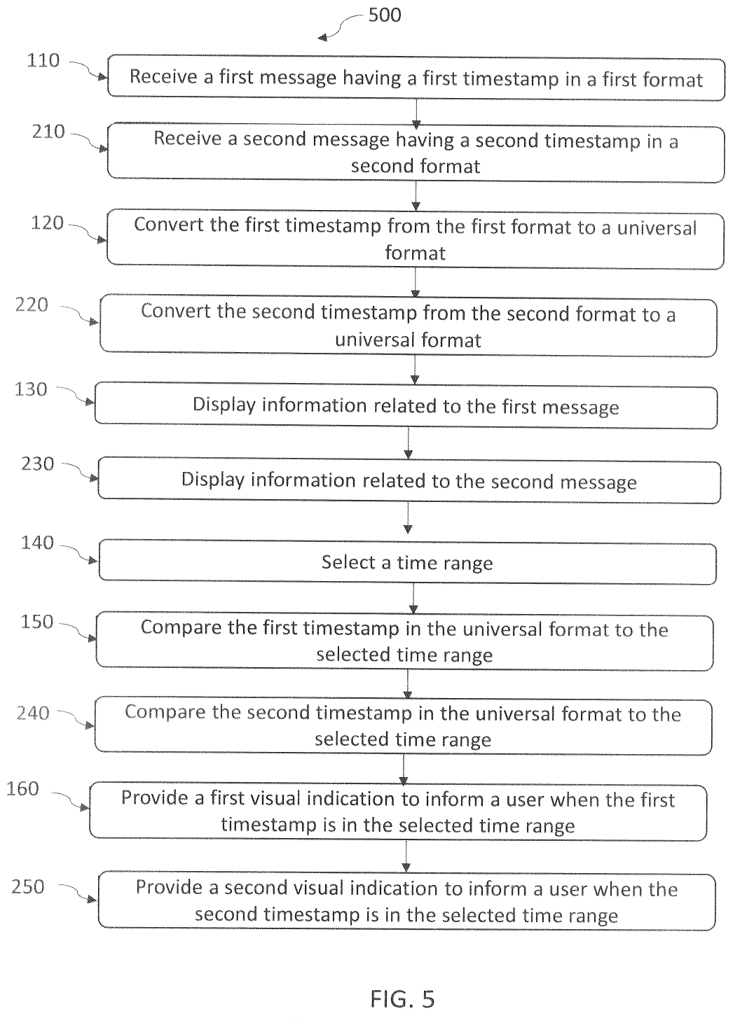

As depicted at least in FIG. 5, the method for displaying synchronized messages 500 may include the steps of: receiving a first message having a first timestamp in a first format (110); receiving a second message having a second timestamp in a second format (210); converting the first timestamp from the first format to a universal format (120); converting the second timestamp from the second format to the universal format (220); displaying information related to the first message (130); displaying information related to the second message (230); selecting a time range (140); comparing the first timestamp in the universal format to the selected time range (150); comparing the second timestamp in the universal format to the selected time range (240); providing a first visual indication to inform a user when the first timestamp is in the selected time range (160); and providing a second visual indication to inform the user when the second timestamp is in the selected time range (250).

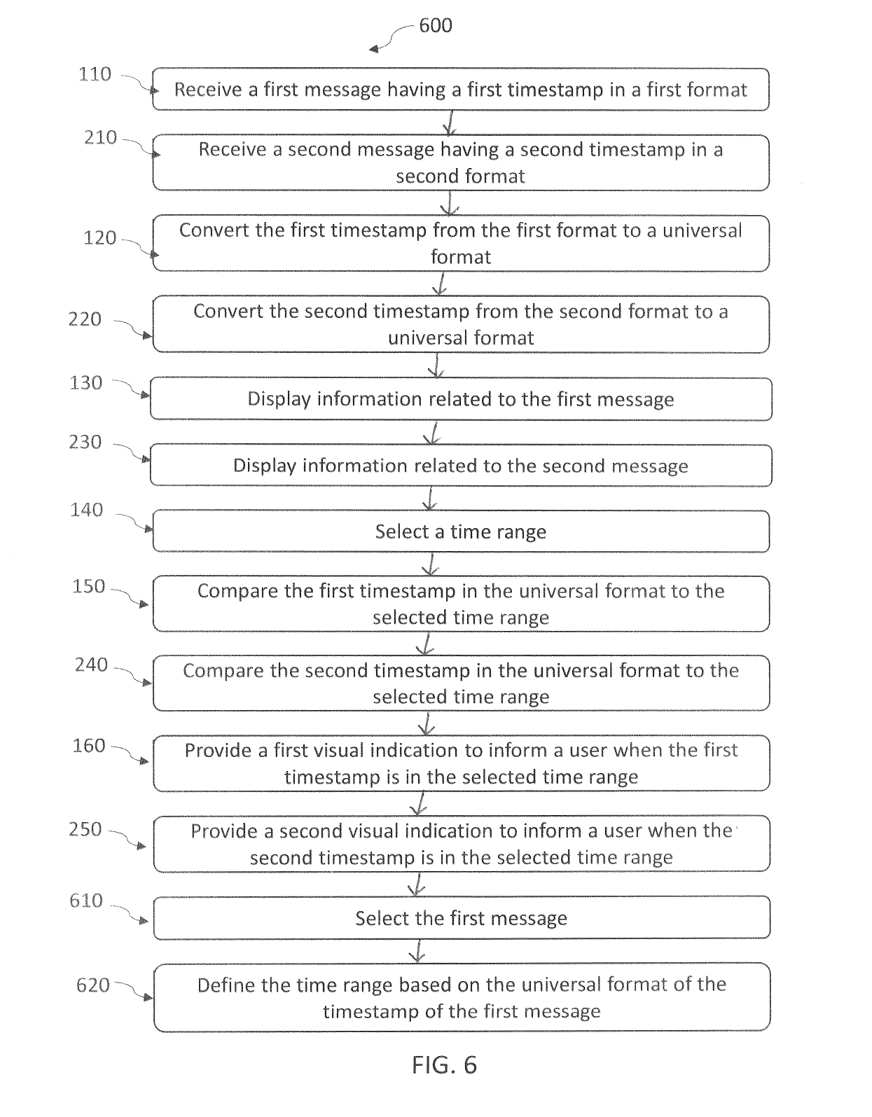

In one embodiment, as depicted at least in FIG. 6, the inventive method may include the steps of: receiving a first message having a first timestamp in a first format (110); receiving a second message having a second timestamp in a second format (210); converting the first timestamp from the first format to a universal format (120); converting the second timestamp from the second format to the universal format (220); displaying information related to the first message (130); displaying information related to the second message (230); selecting a time range (140); comparing the first timestamp in the universal format to the selected time range (150); comparing the second timestamp in the universal format to the selected time range (240); providing a first visual indication to inform a user when the first timestamp is in the selected time range (160); providing a second visual indication to inform the user when the second timestamp is in the selected time range (250); selecting the first message (610); and defining the time range based on the universal format of the timestamp of the first message (620).

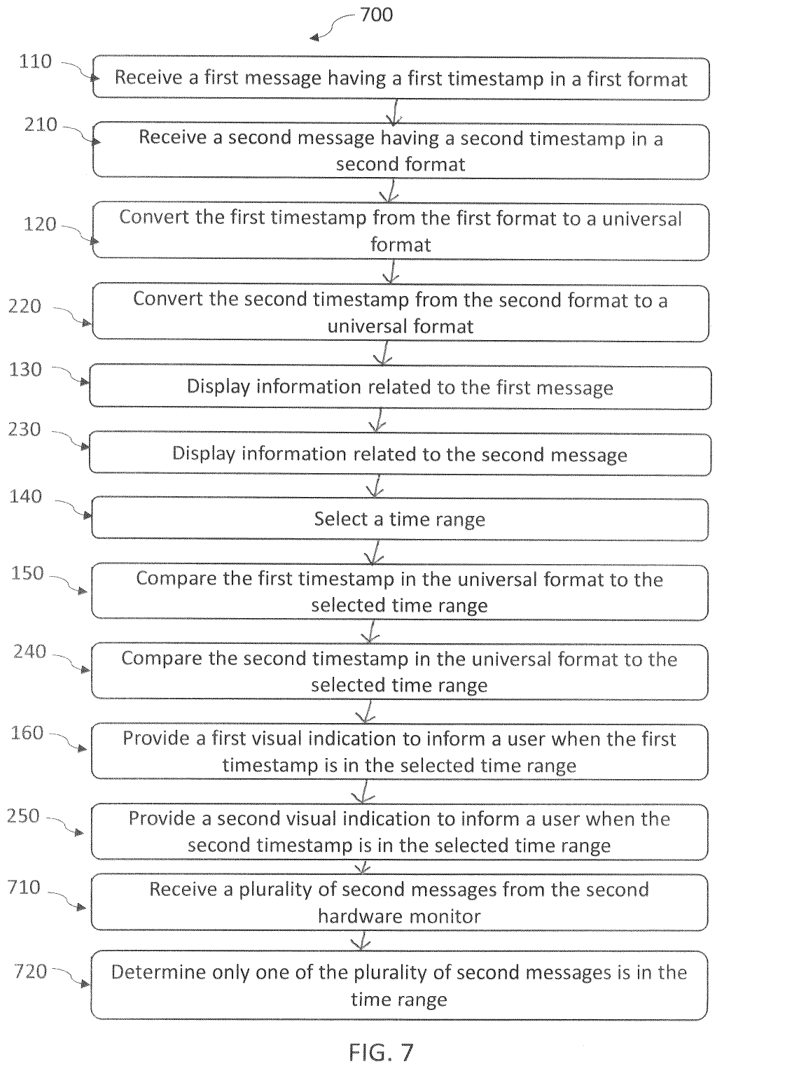

In one embodiment, as depicted at least in FIG. 7, the inventive method may include the steps of: receiving a first message having a first timestamp in a first format (110); receiving a second message having a second timestamp in a second format (210); converting the first timestamp from the first format to a universal format (120); converting the second timestamp from the second format to the universal format (220); displaying information related to the first message (130); displaying information related to the second message (230); selecting a time range (140); comparing the first timestamp in the universal format to the selected time range (150); comparing the second timestamp in the universal format to the selected time range (240); providing a first visual indication to inform a user when the first timestamp is in the selected time range (160); providing a second visual indication to inform the user when the second timestamp is in the selected time range (250); receiving a plurality of second messages from the second hardware monitor (710); and determining only one of the plurality of second messages is in the time range (720).

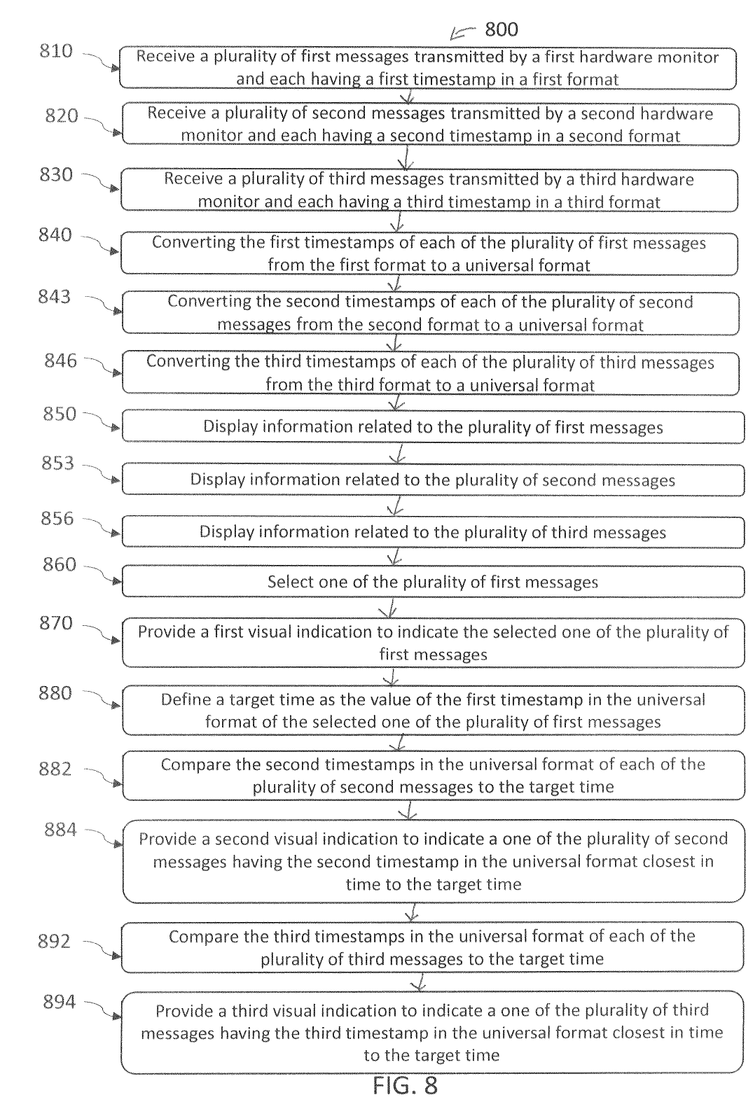

In one embodiment, as depicted at least in FIG. 8, the inventive method may include the steps of: receiving a plurality of first messages transmitted by a first hardware monitor, wherein the each of the plurality of first messages has a first timestamp in a first format (810); receiving a plurality of second messages transmitted by a second hardware monitor, wherein each of the plurality of second messages has a second timestamp in a second format and the second format is different than the first format (820); receiving a plurality of third messages transmitted by a third hardware monitor, wherein each of the plurality of third messages has a third timestamp in a third format and the third format is different than the second format and the first format (830); converting the first timestamps of each of the plurality of first messages from the first format to a universal format (840); converting the second timestamps of each of the plurality of second messages from the second format to the universal format (843); converting the third timestamps of each of the plurality of third messages from the third format to the universal format (846); displaying information related to the plurality of first messages (850); displaying information related to the plurality of second messages (853); displaying information related to the plurality of third messages (856); selecting one of the plurality of first messages (860); providing a first visual indication to indicate the selected one of the plurality of first messages (870); defining a target time as the value of the first timestamp in the universal format of the selected one of the plurality of first messages (880); comparing the second timestamps in the universal format of each of the plurality of second messages to the target time (882); providing a second visual indication to indicate a one of the plurality of second messages having the second timestamp in the universal format closest in time to the target time (884); comparing the third timestamps in the universal format of each of the plurality of third messages to the target time (892); and providing a third visual indication to indicate a one of the plurality of third messages having the third timestamp in the universal format closest in time to the target time (894).

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A method for displaying synchronized messages comprising the steps of:
receiving a first message having a first timestamp in a first format;
converting the first timestamp from the first format to a universal format;
displaying information related to the first message;
selecting a time range;
comparing the first timestamp in the universal format to the selected time range; and
providing a first visual indication to inform a user when the first timestamp is in the selected time range.

2. The method of claim 1 wherein the first message is received from a universal armament interface bus.

3. The method of claim 1 further comprising the steps of:
receiving a second message having a second timestamp in a second format;
converting the second timestamp from the second format to the universal format;
displaying information related to the second message;
comparing the second timestamp in the universal format to the selected time range; and
providing a second visual indication to inform the user when the second timestamp is in the selected time range.

4. The method of claim 2 wherein the first format is different than the second format.

5. The method of claim 2 wherein the first message is transmitted by a first hardware monitor and the second message is transmitted by a second hardware monitor.

6. The method of claim 4 wherein the step of selecting a time range further comprises the steps of:
selecting the first message; and
defining the time range based on the timestamp of the first message.

7. The method of claim 6 further comprising the steps of:
receiving a plurality of second messages from the second hardware monitor; and
providing a second visual indication to inform the user which of the plurality of second messages has a second timestamp in the universal format in the time range.

8. The method of claim 2 wherein the first visual indication and the second visual indication are displayed in a single user interface.

9. A method for displaying synchronized messages comprising the steps of:
receiving a first message having a first timestamp in a first format;
receiving a second message having a second timestamp in a second format;
converting the first timestamp from the first format to a universal format;
converting the second timestamp from the second format to the universal format;
displaying information related to the first message;
displaying information related to the second message;
selecting a time range;
comparing the first timestamp in the universal format to the selected time range;
comparing the second timestamp in the universal format to the selected time range;
providing a first visual indication to inform a user when the first timestamp is in the selected time range; and
providing a second visual indication to inform the user when the second timestamp is in the selected time range.

10. The method of claim 9 wherein the first message is received from a universal armament interface bus and the second message is received from the universal armament interface bus.

11. The method of claim 8 wherein the first format is different than the second format.

12. The method of claim 8 wherein the first message is transmitted by a first hardware monitor and the second message is transmitted by a second hardware monitor.

13. The method of claim 10 wherein the step of selecting a time range further comprises the steps of:
selecting the first message; and
defining the time range based on the universal format of the timestamp of the first message.

14. The method of claim 11 further comprising the steps of:
receiving a plurality of second messages from the second hardware monitor; and
determining only one of the plurality of second messages is the time range.

15. The method of claim 12 wherein each of the plurality of second messages has a timestamp in the second format and further comprises the steps of:
converting the timestamp in the second format of each of the plurality of second messages to the universal format;
comparing the timestamp in the universal format of each of the plurality of second messages to the timestamp in the universal format of the first message; and
selecting only a one of the plurality of second messages having the timestamp in the universal format closest in time to the timestamp in the universal format of the first message to be in the selected time range.

16. The method of claim 13 further comprising the steps of:
receiving a plurality of third messages from a third hardware monitor, wherein each of the plurality of third messages has a timestamp;
converting the timestamp of each of the plurality of third messages to the universal format;
comparing the timestamp in the universal format of each of the plurality of third messages to the timestamp in the universal format of the first message;
selecting only a one of the plurality of third messages having a timestamp in the universal format closest in time to the timestamp in the universal format of the first message to be in the selected time range; and
providing a third visual indication to indicate the one of the plurality of third messages in the selected time range.

17. The method of claim 14 wherein the first visual indication, the second visual indication, and the third visual indication are displayed in a single user interface.

18. The method of claim 8 wherein the first visual indication and the second visual indication are displayed in a single user interface.

19. A method for displaying synchronized messages comprising the steps of:
receiving a plurality of first messages transmitted by a first hardware monitor, wherein the each of the plurality of first messages has a first timestamp in a first format;
receiving a plurality of second messages transmitted by a second hardware monitor, wherein each of the plurality of second messages has a second timestamp in a second format and the second format is different than the first format;
receiving a plurality of third messages transmitted by a third hardware monitor, wherein each of the plurality of third messages has a third timestamp in a third format and the third format is different than the second format and the first format;
converting the first timestamps of each of the plurality of first messages from the first format to a universal format;
converting the second timestamps of each of the plurality of second messages from the second format to the universal format;
converting the third timestamps of each of the plurality of third messages from the third format to the universal format;
displaying information related to the plurality of first messages;
displaying information related to the plurality of second messages;
displaying information related to the plurality of third messages;
selecting one of the plurality of first messages;
providing a first visual indication to indicate the selected one of the plurality of first messages;
defining a target time as the value of the first timestamp in the universal format of the selected one of the plurality of first messages;
comparing the second timestamps in the universal format of each of the plurality of second messages to the target time;
providing a second visual indication to indicate a one of the plurality of second messages having the second timestamp in the universal format closest in time to the target time;
comparing the third timestamps in the universal format of each of the plurality of third messages to the target time; and
providing a third visual indication to indicate a one of the plurality of third messages having the third timestamp in the universal format closest in time to the target time.

20. The method of claim 17 wherein the first visual indication, the second visual indication, and the third visual indication are displayed in a single user interface and the plurality of first messages, plurality of second messages, and plurality of third messages are received from a universal armament interface bus.
